(19) United States
(12) Patent Application Publication
(10) Pub. No.: US 2024/0004909 A1
(43) Pub. Date: Jan. 4, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Saneyuki KOBAYASHI, Kanagawa (JP)

(73) Assignee: FUJIFILM Business Innovation Corp., Tokyo (JP)

(21) Appl. No.: 18/178,626

(22) Filed: Mar. 6, 2023

(30) Foreign Application Priority Data
Jul. 4, 2022 (JP) 2022-108035

(51) Int. Cl. G06F 16/33; G06F 16/31

(52) U.S. Cl. CPC G06F 16/3344; G06F 16/313

(57) ABSTRACT

An information processing apparatus includes a processor configured to: receive an input of a query for a natural text search from a user; receive an execution instruction for the natural text search from the user; acquire information indicating a situation in which the execution instruction for the natural text search was issued; and perform, based on the acquired information, processing of the query.

### CROSS-REFERENCE TO RELATED APPLICATIONS

This application is based on and claims priority under 35 USC 119 from Japanese Patent Application No. 2022-108035 filed Jul. 4, 2022.

### BACKGROUND

### (i) Technical Field

The present disclosure relates to an information processing apparatus, an information processing method, and a non-transitory computer readable medium.

### (ii) Related Art

For example, in Japanese Unexamined Patent Application Publication No. 2021-124913, a search device that performs a search taking into account the versatility of representation of input contents is described. The search device includes a query input unit that receives a search query from a user, a distribution estimation unit that estimates the distribution of search queries in a natural language semantic space, a storage unit that stores information for identifying the distribution of each of a plurality of pieces of predetermined text data in the semantic space, a distribution search unit that searches for text data with a high similarity with a search query on the basis of the information for identifying the distribution of the text data stored in the storage unit and the distribution estimated by the distribution estimation unit, and an output unit that outputs text data found by the distribution search unit.

### SUMMARY

In a system that performs a search in frequently asked questions (FAQ), there are often cases where contents of queries are abstract, words or the like are insufficient, and representation of contents of queries differs depending on users. If the degree of abstractness of a query is high, an appropriate answer may not be able to be obtained.

Aspects of non-limiting embodiments of the present disclosure relate to an information processing apparatus, an information processing method, and a non-transitory computer readable medium capable of making a query input in a natural text search more concrete.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive an input of a query for a natural text search from a user; receive an execution instruction for the natural text search from the user; acquire information indicating a situation in which the execution instruction for the natural text search was issued; and perform, based on the acquired information, processing of the query.

### BRIEF DESCRIPTION OF THE DRAWINGS

Exemplary embodiments of the present disclosure will be described in detail based on the following figures, wherein:

FIG. 1 is a diagram illustrating an example of the configuration of a natural text search system according to a first exemplary embodiment;

FIG. 2 is a block diagram illustrating an example of the electrical configuration of a natural text search apparatus according to the first exemplary embodiment;

FIG. 3 is a block diagram illustrating an example of the functional configuration of the natural text search apparatus according to the first exemplary embodiment;

FIG. 4 is a diagram illustrating an example of an additional sentence table in the first exemplary embodiment;

FIG. 5 is a diagram for explaining a query processing process in the first exemplary embodiment;

FIG. 6 is a diagram illustrating an example of scores provided to feature words in the first exemplary embodiment;

FIG. 7 is a flowchart illustrating an example of the flow of a process based on a natural text search program according to the first exemplary embodiment;

FIG. 8 is a block diagram illustrating an example of the functional configuration of a natural text search apparatus according to a second exemplary embodiment;

FIG. 9 is a diagram illustrating an example of an additional sentence table in the second exemplary embodiment;

FIG. 10 is a diagram for explaining a query processing process in the second exemplary embodiment;

FIG. 11 is a flowchart illustrating an example of the flow of a process based on a natural text search program according to the second exemplary embodiment;

FIG. 12 is a diagram illustrating an example of screen transition of a natural text search screen in an exemplary embodiment;

FIG. 13 is a diagram illustrating another example of the screen transition of the natural text search screen in an exemplary embodiment;

FIG. 14 is a block diagram illustrating an example of the functional configuration of a natural text search apparatus according to a third exemplary embodiment; and

FIG. 15 is a flowchart illustrating an example of the flow of a process based on a natural text search program according to the third exemplary embodiment.

### DETAILED DESCRIPTION

Examples of exemplary embodiments for embodying a technique of the present disclosure will be described in detail below with reference to the drawings. Component elements and processes that are responsible for the same operation and function are denoted by the same reference signs throughout the drawings and redundant description may be omitted in an appropriate manner. Each drawing is merely schematically illustrated to allow sufficient understanding of the technique of the present disclosure. Therefore, the technique of the present disclosure is not limited to examples illustrated in the drawings. Furthermore, description of a configuration not directly linked with the technique of the present disclosure and a known configuration may be omitted.

### First Exemplary Embodiment

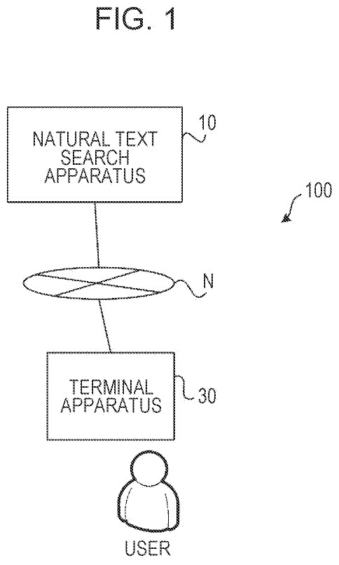

FIG. 1 is a diagram illustrating an example of the configuration of a natural text search system 100 according to a first exemplary embodiment.

As illustrated in FIG. 1, the natural text search system 100 according to the first exemplary embodiment includes a natural text search apparatus 10 and a terminal apparatus 30. In the example of FIG. 1, a single terminal apparatus is illustrated. However, any number of terminal apparatuses may be provided. The natural text search apparatus 10 is an example of an information processing apparatus.

The terminal apparatus 30 is a terminal apparatus used by a user of a natural text search service. The terminal apparatus 30 is, for example, an information terminal such as a smartphone, a tablet terminal, or a personal computer (PC). The user operates the terminal apparatus 30 to access the natural text search apparatus 10 through a network N, and acquires a search result of a query for a natural text search from the natural text search apparatus 10.

The natural text search apparatus 10 is connected to the terminal apparatus 30 through the network N. The network N is, for example, the Internet, a local area network (LAN), a wide area network (WAN), or the like. The natural text search apparatus 10 is, for example, a server computer arranged on the cloud. The natural text search apparatus 10 receives a query for a natural text search input by the user from the terminal apparatus 30, and outputs a search result for the query to the terminal apparatus 30.

In the example of FIG. 1, the natural text search apparatus 10 receives a search query, which is a query input by the user from the terminal apparatus 30. However, the natural text search apparatus 10 does not necessarily receive a search query from the terminal apparatus 30. The natural text search apparatus 10 may receive a search query that the user has input directly on an operation unit of the natural text search apparatus 10.

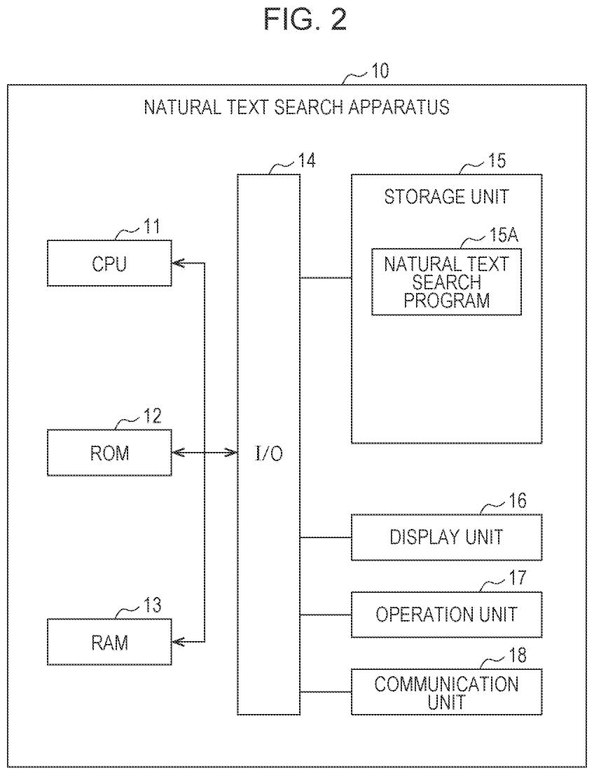

FIG. 2 is a block diagram illustrating an example of the electrical configuration of the natural text search apparatus 10 according to the first exemplary embodiment.

As illustrated in FIG. 2, the natural text search apparatus 10 according to the first exemplary embodiment includes a central processing unit (CPU) 11, a read only memory (ROM) 12, a random access memory (RAM) 13, an input/output interface (I/O) 14, a storage unit 15, a display unit 16, an operation unit 17, and a communication unit 18.

The CPU 11, the ROM 12, the RAM 13, and the I/O 14 are connected to one another through a bus. Functional units including the storage unit 15, the display unit 16, the operation unit 17, and the communication unit 18 are connected to the I/O 14. These functional units are able to communicate with the CPU 11 through the I/O 14.

The CPU 11, the ROM 12, the RAM 13, and the I/O 14 configure a controller. The controller may be configured as a sub-controller that controls part of operation of the natural text search apparatus 10 or may be configured as part of a main controller that controls the entire operation of the natural text search apparatus 10. Part of or all the blocks of the controller include, for example, an integrated circuit such as a large scale integration (LSI) or an IC chip set. The blocks include individual circuits or a partially or entirely integrated circuit. The blocks may be provided in an integrated manner or part of the blocks may be provided separately. Furthermore, part of each of the blocks may be provided separately. Integration of the controller is not necessarily implemented by LSI and may be implemented by a dedicated circuit or a general-purpose processor.

For example, a hard disk drive (HDD), a solid state drive (SSD), a flash memory, or the like may be used as the storage unit 15. A natural text search program 15A for executing a natural text search service according to the first exemplary embodiment is stored in the storage unit 15. The natural text search program 15A may be stored in the ROM 12.

The natural text search program 15A may be, for example, installed in advance into the natural text search apparatus 10. The natural text search program 15A may be implemented by being stored in a nonvolatile storage medium or distributed through the network N and installed into the natural text search apparatus 10 in an appropriate manner. The nonvolatile storage medium may be, for example, a compact disc-read only memory (CD-ROM), a magneto-optical disk, an HDD, a digital versatile disc-read only memory (DVD-ROM), a flash memory, a memory card, or the like.

The display unit 16 is, for example, a liquid crystal display (LCD), an organic electroluminescence (EL) display, or the like. The display unit 16 may include a touch panel integrally provided. The operation unit 17 includes, for example, an operation input device such as a keyboard and a mouse. The display unit 16 and the operation unit 17 receive various instructions from a user of the natural text search apparatus 10. The display unit 16 displays a result of a process performed in response to an instruction received from a user and various types of information such as a notification for the process.

For example, the communication unit 18 is connected to the network N such as the Internet, the LAN, or the WAN and is able to communicate with the terminal apparatus 30 through the network N.

As described above, in the natural text search system 100, there are often cases where contents of queries are abstract, words or the like are insufficient, and representation of contents of queries differs depending on users. If the degree of abstractness of a query is high, an appropriate answer may not be able be obtained.

In contrast, the natural text search apparatus 10 according to the first exemplary embodiment receives an input of a query for a natural text search from a user, receives an execution instruction for the natural text search from the user, acquires information indicating a situation in which the execution instruction for the natural text search was issued, and performs, based on the acquired information, processing of the query.

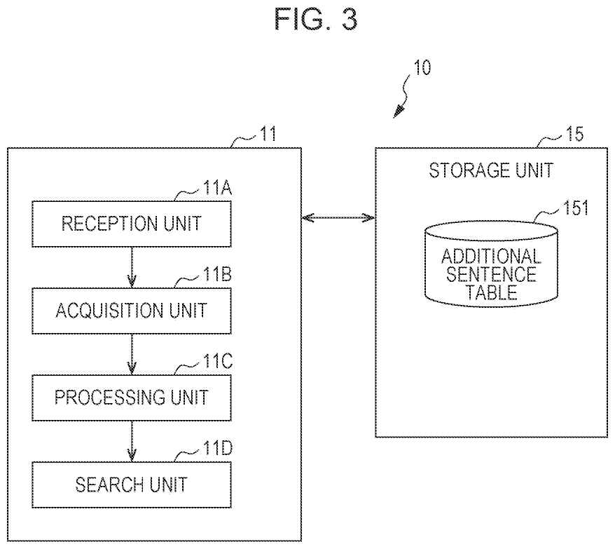

Specifically, the CPU 11 of the natural text search apparatus 10 according to the first exemplary embodiment functions as units illustrated in FIG. 3 by writing the natural text search program 15A stored in the storage unit 15 into the RAM 13 and executing the natural text search program 15A. The CPU 11 is an example of a processor.

FIG. 3 is a block diagram illustrating an example of the functional configuration of the natural text search apparatus 10 according to the first exemplary embodiment.

As illustrated in FIG. 3, the CPU 11 of the natural text search apparatus 10 according the first exemplary embodiment functions as a reception unit 11A, an acquisition unit 11B, a processing unit 11C, and a search unit 11D.

The reception unit 11A receives an input of a query for a natural text search by a user from the terminal apparatus 30 and receives an execution instruction for the natural text search from the user.

When the reception unit 11A receives an execution instruction for a natural text search, the acquisition unit 11B acquires information indicating a situation in which the execution instruction for the natural text search was issued. The “information indicating a situation in which the execution instruction was issued” represents, for example, content information that the user was referring to when issuing the execution instruction. For example, a uniform resource locator (URL) indicating a reference source of the content information is associated with the content information.

The processing unit 11C performs processing of a query on the basis of information acquired by the acquisition unit 11B. Specifically, the processing unit 11C extracts a sentence or a feature word to be reflected in a query from content information that the user was referring to when issuing an execution instruction, and performs processing of the query on the basis of the extracted sentence or feature word. The term “processing” used here may represent, for example, adding the extracted sentence or feature word to the query or generating a new query based on the extracted sentence or feature word and the query.

The processing unit 11C may perform control in such a manner that the processed query is displayed on the terminal apparatus 30 and prompt the user to confirm the processed query. Furthermore, the processing unit 11C may perform control in such a manner that a plurality of processed queries are displayed on the terminal apparatus 30 and receive a selection of one of the plurality of processed queries from the user.

The search unit 11D conducts a natural text search regarding a processed query that has been obtained by the processing by the processing unit 11C and outputs a search result to the terminal apparatus 30.

An additional sentence table 151 is stored in the storage unit 15. Extraction of a sentence or a feature word to be reflected in a query is performed, for example, with reference to the additional sentence table 151.

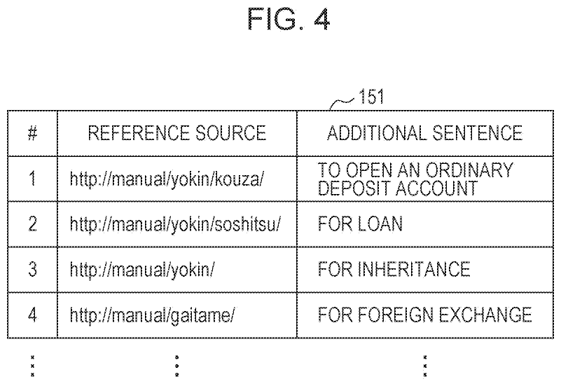

FIG. 4 is a diagram illustrating an example of the additional sentence table 151 in the first exemplary embodiment.

In the additional sentence table 151 illustrated in FIG. 4, reference sources (URLs) of content information that the user is able to refer to and additional sentences are defined in association with each other. An additional sentence is a characteristic sentence representing content information. Instead of an additional sentence, an additional feature word may be defined in association with a reference source of content information. An additional feature word is a characteristic word representing content information.

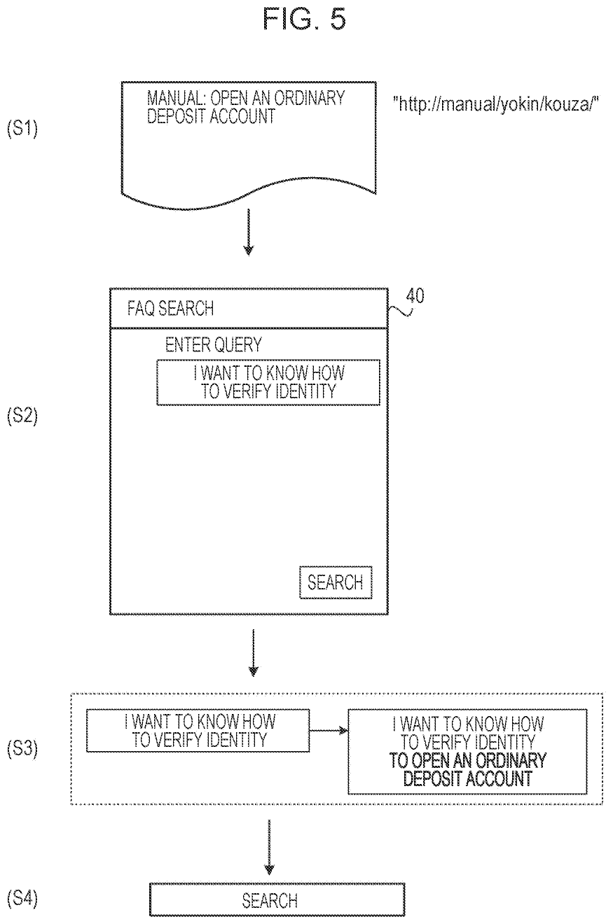

FIG. 5 is a diagram for explaining a query processing process in the first exemplary embodiment.

In (S1) of FIG. 5, the user operates the terminal apparatus 30 to access content information (for example, manual: open an ordinary deposit account). A reference source (URL) “http://manual/yokin/kouza/” is associated with the content information.

In (S2), in the case where the user wants to make a query while referring to the content information, a natural text search screen 40 is displayed on the terminal apparatus 30. For example, on the natural text search screen 40, the user enters a query “I want to know how to verify identity” and presses a “search” button.

In (S3), when the reception unit 11A of the natural text search apparatus 10 receives the query entered through the natural text search screen 40 and an instruction for conducting a search, the acquisition unit 11B acquires a reference source (URL) of the content information that the user is referring to from the terminal apparatus 30. Then, the processing unit 11C refers to, for example, the additional sentence table 151 illustrated in FIG. 4, on the basis of the acquired reference source (URL) of the content information, and extracts an additional sentence. In the example of FIG. 5, as the additional sentence, “to open an ordinary deposit account” is extracted. Then, the processing unit 11C adds the extracted sentence to the query to generate, for example, a new query “I want to know how to verify identity to open an ordinary deposit account.” That is, the original abstract query “I want to know how to verify identity” is automatically processed into the query “I want to know how to verify identity to open an ordinary deposit account,” which is more concrete than the original abstract query.

In (S4), the search unit 11D of the natural text search apparatus 10 conducts a natural text search regarding the processed query that has been obtained by (S3) described above, and causes a search result to be displayed on the natural text search screen 40 of the terminal apparatus 30.

A sentence or a feature word to be reflected in a query may be extracted without reference to the additional sentence table 151 described above. In this case, content information itself may be acquired from the reference source (URL) of the content information, and a sentence or a feature word to be reflected in a query may be extracted from, for example, a title, a summary part, a header part, or the like of the content information.

Furthermore, although the case where a sentence is added to an original query has been described above, a feature word may be added to an original query. In this case, for example, the processing unit 11C provides feature words with scores, and extracts a predetermined number of feature words in descending order of the scores.

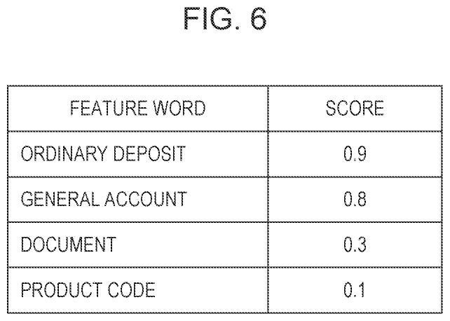

FIG. 6 is a diagram illustrating an example of scores provided to feature words in the first exemplary embodiment.

As illustrated in FIG. 6, feature words extracted from content information are provided with scores. For example, scores are provided using a term frequency-inverse document frequency (TF-IDF) method or the like. The TF-IDF is a statistical measure (numerical value) that aims to reflect how important a word is. In this case, the processing unit 11C extracts one or two feature words in descending order of scores represented by the TF-IDF. Furthermore, a predetermined threshold may be set for scores so that a feature word with a score equal to or more than the threshold is extracted. In the example of FIG. 6, “ordinary deposit” and “general account” are extracted as additional feature words. Then, the processing unit 11C adds the extracted feature words to the query to generate, for example, a new query “I want to know how to verify identity for an ordinary deposit and a general account.” That is, the original abstract query “I want to know how to verify identity” is automatically processed into the query “I want to know how to verify identity for an ordinary deposit and a general account,” which is more concrete than the original abstract query.

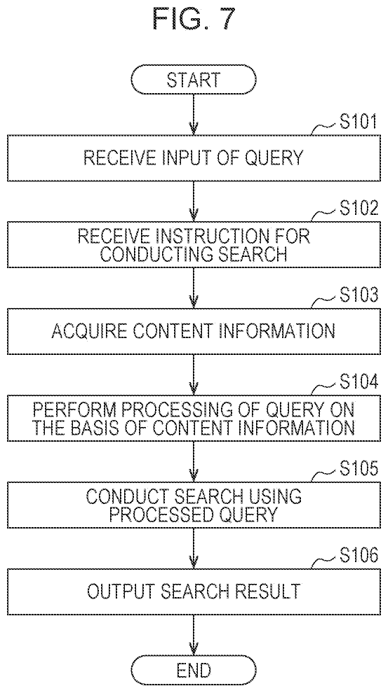

Next, an operation of the natural text search apparatus 10 according to the first exemplary embodiment will be described with reference to FIG. 7.

FIG. 7 is a flowchart illustrating an example of the flow of a process based on the natural text search program 15A according to the first exemplary embodiment.

First, the CPU 11 of the natural text search apparatus 10 starts the natural text search program 15A, and performs steps described below. In this example, as illustrated in FIG. 5, the user operates the terminal apparatus 30 to access content information (for example, manual: open an ordinary deposit account) and refers to the content information.

In step S101 of FIG. 7, in accordance with an operation for the terminal apparatus 30 by the user, for example, the CPU 11 causes the natural text search screen 40 illustrated in FIG. 5 to be displayed on the terminal apparatus 30, and receives an input of a query from the natural text search screen 40.

In step S102, for example, when the “search” button on the natural text search screen 40 illustrated in FIG. 5 is pressed, the CPU 11 receives an instruction for conducting a search.

In step S103, the CPU 11 acquires a reference source (URL) of the content information that the user is referring to from the terminal apparatus 30.

In step S104, based on the reference source (URL) of the content information acquired in step S103, for example, the CPU 11 refers to the additional sentence table 151 illustrated in FIG. 4 to extract an additional sentence, and performs processing of the query by adding the extracted sentence to the query. Thus, for example, an original abstract query “I want to know how to verify identity” is automatically processed into a query “I want to know how to verify identity to open an ordinary deposit account,” which is more concrete than the original abstract query.

In step S105, the CPU 11 conducts a natural text search regarding the processed query that has been obtained by the processing in step S104.

In step S106, the CPU 11 outputs a search result of the natural text search conducted in step S105 to the terminal apparatus 30, and ends a series of processing operations based on the natural text search program 15A.

As described above, according to the first exemplary embodiment, a sentence or a feature word to be reflected in a query is extracted from content information that the user was referring to when issuing an instruction for conducting a search. Thus, a query entered for a natural text search is made more concrete, and a more accurate search result is able to be obtained.

### Second Exemplary Embodiment

In the first exemplary embodiment described above, an aspect in which processing of a query is performed based on content information has been described. In a second exemplary embodiment, an aspect in which processing of a query is performed based on workflow information will be described.

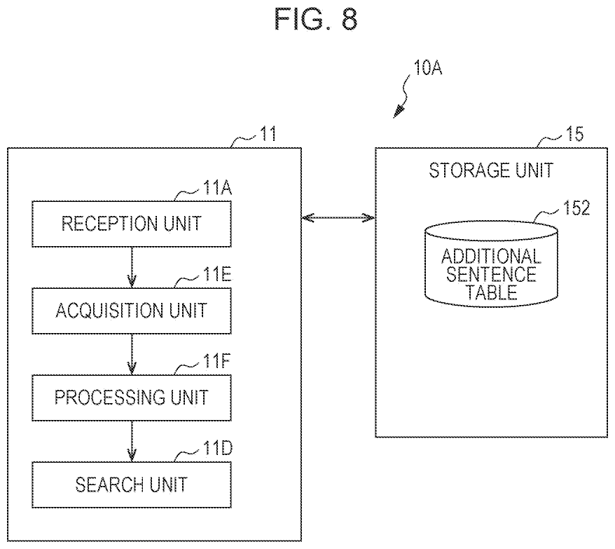

FIG. 8 is a block diagram illustrating an example of the functional configuration of a natural text search apparatus 10A according to the second exemplary embodiment.

As illustrated in FIG. 8, the CPU 11 of the natural text search apparatus 10A according to the second exemplary embodiment functions as a reception unit 11A, an acquisition unit 11E, a processing unit 11F, and a search unit 11D. The same component elements as those of the natural text search apparatus 10 described above in the first exemplary embodiment will be denoted by the same reference signs, and redundant description will be omitted.

When the reception unit 11A receives an execution instruction for a natural text search, the acquisition unit 11E acquires information indicating a situation in which the execution instruction for the natural text search was issued. The “information indicating a situation in which the execution instruction was issued” represents, for example, workflow information that the user was referring to when issuing the execution instruction. For example, a case and a phase of workflow information are associated with the workflow information.

The processing unit 11F performs processing of a query on the basis of information acquired by the acquisition unit 11E. Specifically, the processing unit 11F extracts a sentence or a feature word to be reflected in a query from workflow information that the user was referring to when issuing an execution instruction, and performs processing of the query on the basis of the extracted sentence or feature word. As described above, the term “processing” used here may represent, for example, adding the extracted sentence or feature word to the query or generating a new query based on the extracted sentence or feature word and the query.

The search unit 11D conducts a natural text search regarding a processed query that has been obtained by the processing by the processing unit 11F and outputs a search result to the terminal apparatus 30.

An additional sentence table 152 is stored in the storage unit 15. Extraction of a sentence or a feature word to be reflected in a query is performed, for example, with reference to the additional sentence table 152.

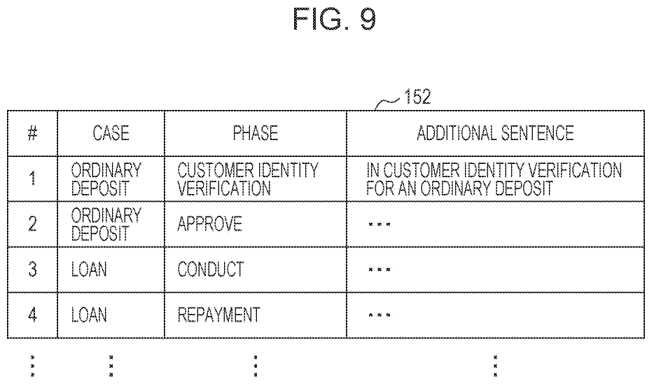

FIG. 9 is a diagram illustrating an example of the additional sentence table 152 in the second exemplary embodiment.

In the additional sentence table 152 illustrated in FIG. 9, a case, a phase, and an additional sentence of workflow information that the user is able to refer to are defined in association with one another. An additional sentence is a characteristic sentence representing workflow information. Instead of an additional sentence, an additional feature word may be defined in association with a case and a phase. An additional feature word is a characteristic word representing workflow information.

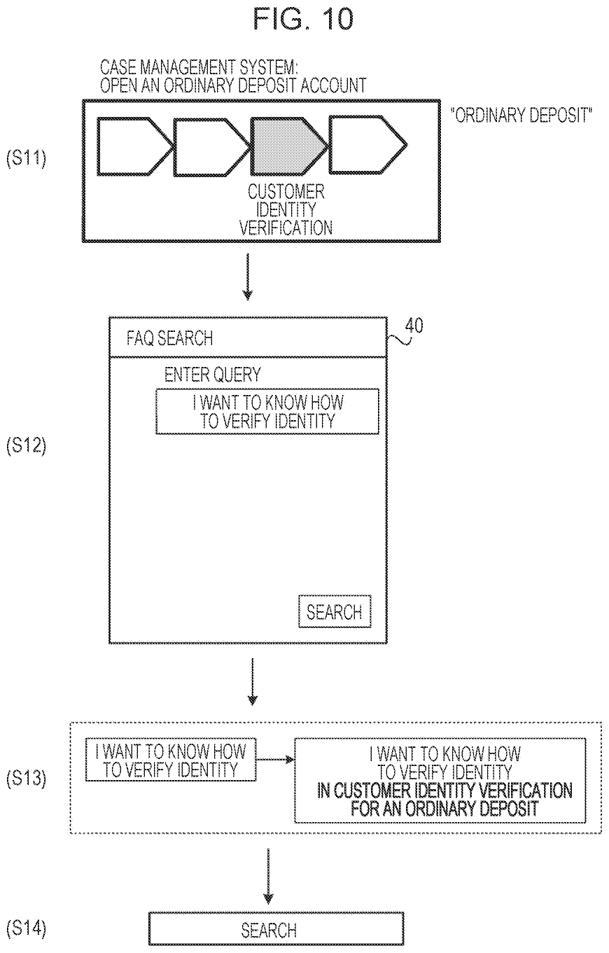

FIG. 10 is a diagram for explaining a query processing process in the second exemplary embodiment.

In (S11) of FIG. 10, the user operates the terminal apparatus 30 to access workflow information (for example, case management system: open an ordinary deposit account). A case “ordinary deposit” and a phase “customer identity verification” are associated with the workflow information.

In (S12), in the case where the user wants to make a query while referring to the workflow information, the natural text search screen 40 is displayed on the terminal apparatus 30. The user enters, for example, a query “I want to know how to verify identity” on the natural text search screen 40, and presses a “search” button.

In (S13), when the reception unit 11A of the natural text search apparatus 10A receives the query entered through the natural text search screen 40 and an instruction for conducting a search, the acquisition unit 11E acquires the case and the phase of the workflow information that the user is referring to from the terminal apparatus 30. Then, the processing unit 11F refers to, for example, the additional sentence table 152 illustrated in FIG. 9, on the basis of the acquired case and phase of the workflow information, and extracts an additional sentence. In the example of FIG. 10, as an additional sentence, “in customer identity verification for an ordinary deposit” is extracted. Then, the processing unit 11F adds the extracted sentence to the query to generate, for example, a new query “I want to know how to verify identity in customer identity verification for an ordinary deposit.” That is, the original abstract query “I want to know how to verify identity” is automatically processed into the query “I want to know how to verify identity in customer identity verification for an ordinary deposit,” which is more concrete than the original abstract query.

In (S14), the search unit 11D of the natural text search apparatus 10A conducts a natural text search regarding the processed query that has been obtained by (S13) described above, and causes a search result to be displayed on the natural text search screen 40 of the terminal apparatus 30.

Although the case where a sentence is added to an original query has been described above, a feature word may be added to an original query. In this case, for example, the processing unit 11F provides feature words with scores, and extracts a predetermined number of feature words in descending order of the scores, as with the content information described above.

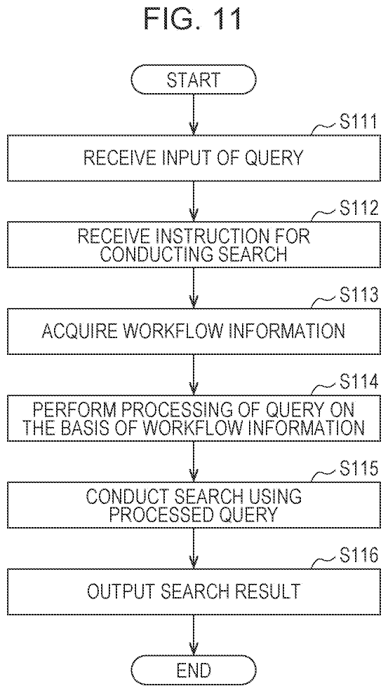

Next, an operation of the natural text search apparatus 10A according to the second exemplary embodiment will be described with reference to FIG. 11.

FIG. 11 is a flowchart illustrating an example of the flow of a process based on the natural text search program 15A according to the second exemplary embodiment.

First, the CPU 11 of the natural text search apparatus 10A starts the natural text search program 15A, and performs steps described below. In this example, as illustrated in FIG. 10, the user operates the terminal apparatus 30 to access workflow information (for example, case management system: open an ordinary deposit account) and refers to the workflow information.

In step S111 of FIG. 11, in accordance with an operation for the terminal apparatus 30 by the user, for example, the CPU 11 causes the natural text search screen 40 illustrated in FIG. 10 to be displayed on the terminal apparatus 30 and receives an input of a query from the natural text search screen 40.

In step S112, for example, when the “search” button on the natural text search screen 40 illustrated in FIG. 10 is pressed, the CPU 11 receives an instruction for conducting a search.

In step S113, the CPU 11 acquires a case and a phase of the workflow information that the user is referring to from the terminal apparatus 30.

In step S114, based on the case and the phase of the workflow information acquired in step S113, for example, the CPU 11 refers to the additional sentence table 152 illustrated in FIG. 9 to extract an additional sentence, and performs processing of the query by adding the extracted sentence to the query. Thus, for example, an original abstract query “I want to know how to verify identity” is automatically processed into a query “I want to know how to verify identity in customer identity verification for an ordinary deposit,” which is more concrete than the original abstract query.

In step S115, the CPU 11 conducts a natural text search regarding the processed query that has been obtained by the processing in step S114.

In step S116, the CPU 11 outputs a search result of the natural text search conducted in step S115 to the terminal apparatus 30, and ends a series of processing operations based on the natural text search program 15A.

As described above, according to the second exemplary embodiment, a sentence or a feature word to be reflected in a query is extracted from workflow information that the user was referring to when issuing an instruction for conducting a search. Thus, a query entered for a natural text search is made more concrete, and a more accurate search result is able to be obtained.

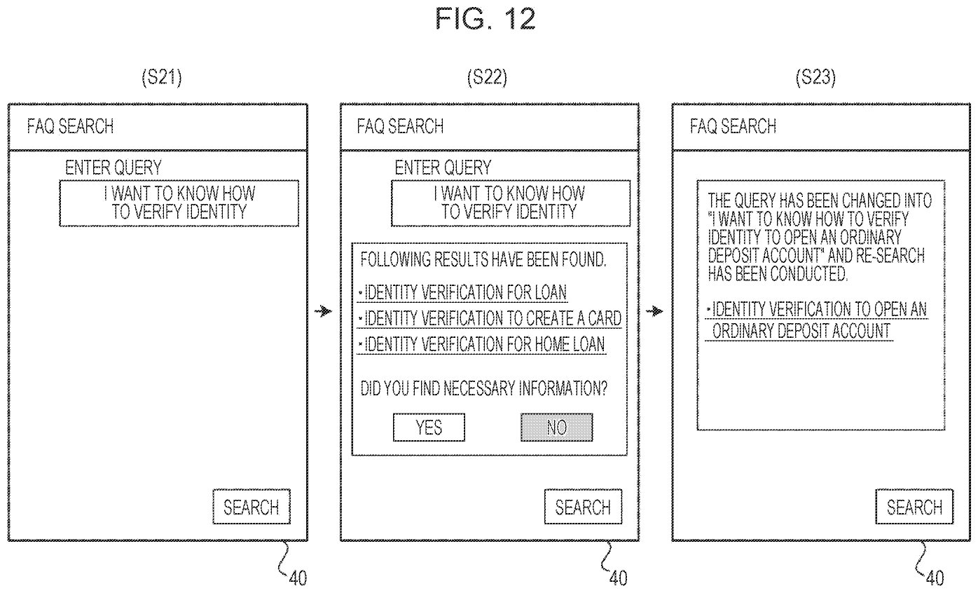

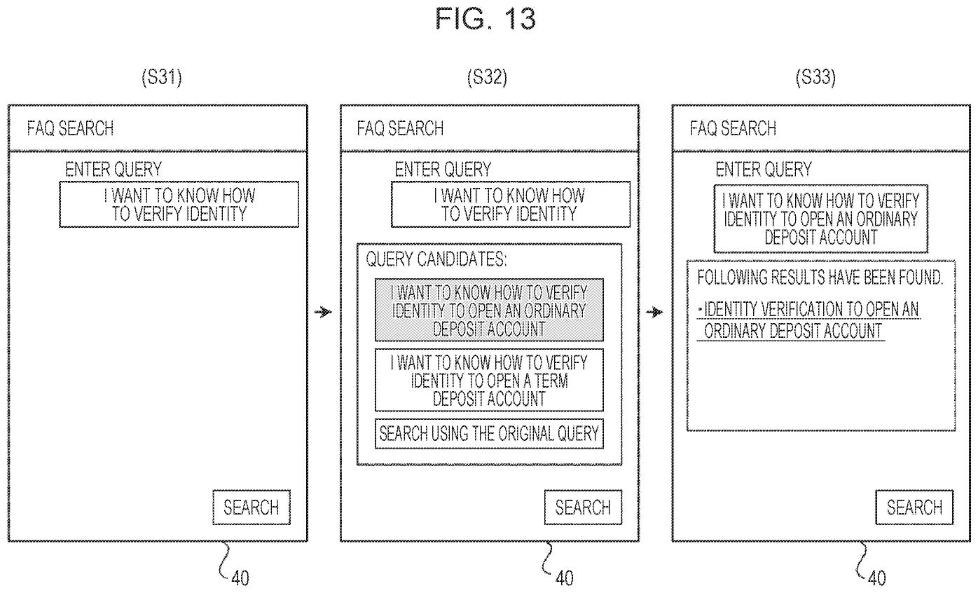

Next, screen transition of the natural text search screen 40 displayed on the terminal apparatus 30 will be described with reference to FIGS. 12 and 13.

FIG. 12 is a diagram illustrating an example of screen transition of the natural text search screen 40 according to the second exemplary embodiment.

In (S21) of FIG. 12, the user enters, for example, a query “I want to know how to verify identity” on the natural text search screen 40 and presses the “search” button.

In (S22), a natural text search regarding the entered query “I want to know how to verify identity” is conducted, and a search result is displayed on the natural text search screen 40. In this case, “identity verification for loan,” “identity verification to create a card,” and “identity verification for home loan” are found as search results. In the case where desired information is included in the search results, the user presses a “YES” button. In the case where desired information is not included in the search results, the user presses a “NO” button. In the example of FIG. 12, the “NO” button is pressed.

In (S23), a sentence is added to the original query, a re-search is conducted, and a re-search result is displayed again on the natural text search screen 40. For example, a re-search result “Identity verification to open an ordinary deposit account” is obtained, along with a message “The query has been changed into ‘I want to know how to verify identity to open an ordinary deposit account’ and re-search has been conducted.”

FIG. 13 is a diagram illustrating another example of screen transition of the natural text search screen 40 in the second exemplary embodiment.

In (S31) of FIG. 13, the user enters, for example, a query “I want to know how to verify identity” on the natural text search screen 40 and presses the “search” button.

In (S32), candidates for a query (query candidates) obtained by adding a sentence to the original query are displayed on the natural text search screen 40. As query candidates, for example, “I want to know how to verify identity to open an ordinary deposit account,” “I want to know how to verify identity to open a term deposit account,” and “search using the original query” are displayed in such a manner one of the candidates is able to be selected by the user. In the example of FIG. 13, “I want to know how to verify identity to open an ordinary deposit account” is selected.

In (S33), a natural text search is conducted using the selected query, and a search result is displayed on the natural text search screen 40. For example, the query “I want to know how to verify identity open an ordinary deposit account” and a search result “identity verification to open an ordinary deposit account” are obtained.

### Third Exemplary Embodiment

In a third exemplary embodiment, an aspect in which the degree of abstractness of an original query is determined, and processing of the query is performed only when the degree of abstractness is high will be described.

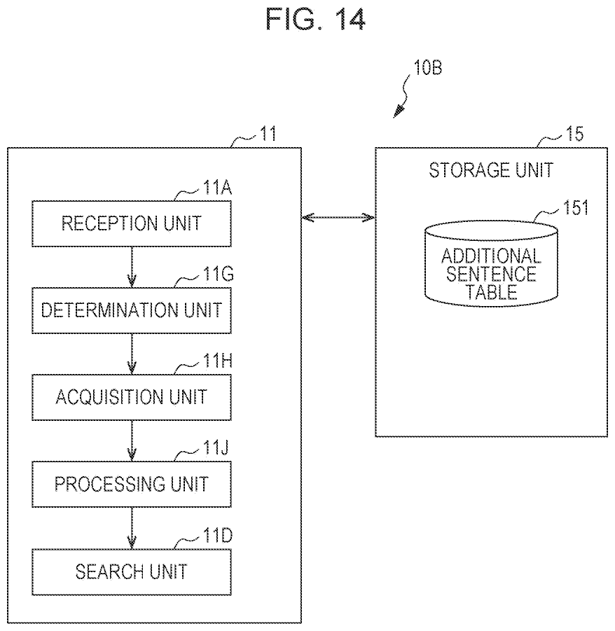

FIG. 14 is a block diagram illustrating an example of the functional configuration of a natural text search apparatus 10B according to the third exemplary embodiment.

As illustrated in FIG. 14, the CPU 11 of the natural text search apparatus 10B according to the third exemplary embodiment functions as a reception unit 11A, a determination unit 11G, an acquisition unit 11H, a processing unit 11J, and a search unit 11D. The same component elements as those of the natural text search apparatus 10 described above in the first exemplary embodiment will be denoted by the same reference signs and redundant description will be omitted.

The determination unit 11G determines whether or not the degree of abstractness of a query received by the reception unit 11A is equal to or more than a threshold. For example, the degree of abstractness is determined based on the number of search results obtained by a natural text search based on a query. In the case where a large number of search results are obtained by a search based on a query, the query is considered to be abstract. Thus, the larger the number of search results, the higher the degree of abstractness. Furthermore, the degree of abstractness may be determined based on the number of predetermined keywords included in search results obtained by a natural text search based on a query. A keyword represents a word that is highly associated with content information that the user refers to. In the case where a large number of keywords are included in search results obtained by a search based on a query, the query is considered to be concrete. Thus, the smaller then number of keywords, the higher the degree of abstractness. For example, in the case where the degree of abstractness is expressed in ten levels from 1 to 10, the threshold is set to, for example, “7” in advance.

In the case where it is determined by the determination unit 11G that the degree of abstractness is equal to or more than the threshold, that is, in the case where it is determined that the degree of abstractness is relatively high, the acquisition unit 11H acquires information indicating a situation in which the execution instruction for the natural text search was issued. The “information indicating a situation in which the execution instruction was issued” represents, for example, content information that the user was referring to when issuing the execution instruction. For example, an URL indicating a reference source of the content information is associated with the content information.

The processing unit 11J performs processing of a query on the basis of information acquired by the acquisition unit 11H. Specifically, the processing unit 11J extracts a sentence or a feature word to be reflected in a query from content information that the user was referring to when issuing an execution instruction, and performs processing of the query on the basis of the extracted sentence or feature word. The term “processing” used here may represent, for example, adding the extracted sentence or feature word to the query or generating a new query based on the extracted sentence or feature word and the query. That is, only in the case where the degree of abstractness of an original query is relatively high, the processing unit 11J performs processing of the query on the basis of content information.

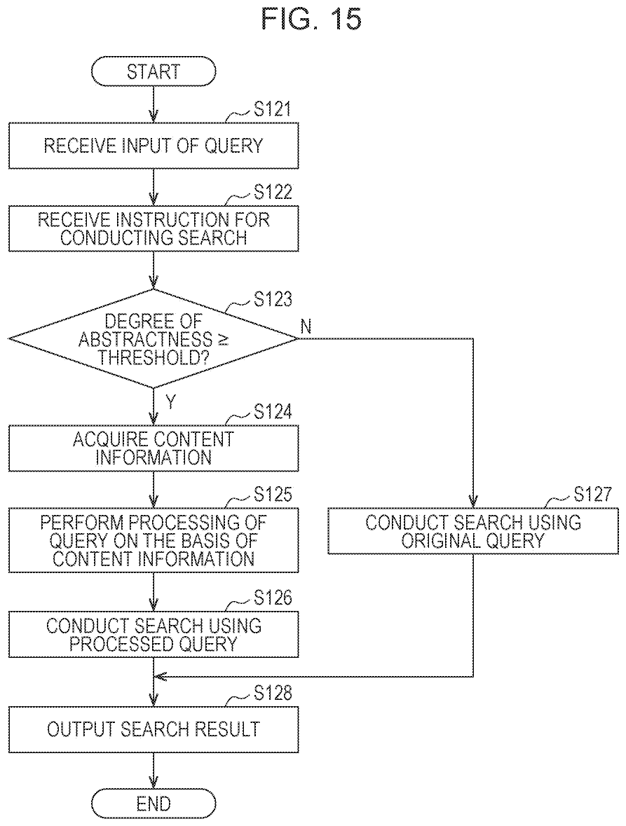

Next, an operation of the natural text search apparatus 10B according to the third exemplary embodiment will be described with reference to FIG. 15.

FIG. 15 is a flowchart illustrating an example of the flow of a process based on the natural text search program 15A according to the third exemplary embodiment.

First, the CPU 11 of the natural text search apparatus 10B starts the natural text search program 15A, and performs steps described below. In this example, as illustrated in FIG. 5, the user operates the terminal apparatus 30 to access content information (for example, manual: open an ordinary deposit account) and refers to the content information.

In step S121 of FIG. 15, in accordance with an operation for the terminal apparatus 30 by the user, for example, the CPU 11 causes the natural text search screen 40 illustrated in FIG. 5 to be displayed on the terminal apparatus 30 and receives an input of a query from the natural text search screen 40.

In step S122, for example, when the “search” button on the natural text search screen 40 illustrated in FIG. 5 is pressed, the CPU 11 receives an instruction for conducting a search.

In step S123, the CPU 11 determines whether or not the degree of abstractness of the query is equal to or more than a threshold. In the case where it is determined that the degree of abstractness of the query is equal to or more than the threshold (in the case where the result of the determination is affirmative), the process proceeds to step S124. In the case where it is determined that the degree of abstractness of the query is less than the threshold (in the case where the result of the determination is negative), the process proceeds to step S127.

In step S124, the CPU 11 acquires a reference source (URL) of the content information that the user is referring to from the terminal apparatus 30.

In step S125, based on the reference source (URL) of the content information acquired in step S124, for example, the CPU 11 refers to the additional sentence table 151 illustrated in FIG. 4 to extract an additional sentence, and performs processing of the query by adding the extracted sentence to the query. Thus, for example, an original abstract query “I want to know how to verify identity” is automatically processed into a query “I want to know how to verify identity to open an ordinary deposit account,” which is more concrete than the original abstract query.

In step S126, the CPU 11 conducts a natural text search regarding the processed query that has been obtained by the processing in step S125, and the process proceeds to step S128.

In contrast, in step S127, the CPU 11 conducts a natural text search regarding the original query received in step S121, and the process proceeds to step S128.

In step S128, the CPU 11 outputs a search result of the natural text search conducted in step S126 or S127 to the terminal apparatus 30, and ends a series of processing operations based on the natural text search program 15A.

As described above, according to the third exemplary embodiment, the degree of abstractness of an original query is determined, and processing of the query is performed only when the degree of abstractness is high. Thus, only a query with a high degree of abstractness is selectively made more concrete.

As an example of an information processing apparatus according to an exemplary embodiment, a natural text search apparatus has been described. An exemplary embodiment may be an aspect in which a program causing a computer to execute functions of units included in an information processing apparatus is provided. An exemplary embodiment may be an aspect in which a non-transitory computer-readable storage medium storing a program mentioned above is provided.

A configuration of an information processing apparatus described above in an exemplary embodiment is an example, and a change may be made according to circumstances without departing from a spirit of the present disclosure.

Furthermore, the flow of a process of a program described above in an exemplary embodiment is also an example. An unnecessary step may be deleted, a new step may be added, or the processing order may be changed without departing from the spirit of the present disclosure.

Furthermore, although a case where a process according to an exemplary embodiment is implemented by a software configuration using a computer by execution of a program has been described in an exemplary embodiment, an exemplary embodiment is not necessarily implemented by a software configuration. An exemplary embodiment may be implemented by, for example, a hardware configuration or a combination of a hardware configuration and a software configuration.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

According to (((1))), an information processing apparatus comprising a processor configured to: receive an input of a query for a natural text search from a user; receive an execution instruction for the natural text search from the user; acquire information indicating a situation in which the execution instruction for the natural text search was issued; and perform, based on the acquired information, processing of the query.

According to (((2))), the information processing apparatus according to (((1))), wherein the information indicating the situation in which the execution instruction was issued from the user is content information that the user was referring to when issuing the execution instruction, and wherein the processor is configured to extract a sentence or a feature word to be reflected in the query from the content information.

According to (((3))), the information processing apparatus according to (((2))), wherein the processing is adding the extracted sentence or feature word to the query.

According to (((4))), the information processing apparatus according to (((2))), wherein the processing is generating a new query based on the extracted sentence or feature word and the query.

According to (((5))), the information processing apparatus according to any one of (((2))) to (((4))), wherein the processor is configured to provide feature words with scores and extract a predetermined number of feature words in descending order of the scores.

According to (((6))), the information processing apparatus according to (((1))), wherein the information indicating the situation in which the execution instruction was issued from the user is workflow information that the user was referring to when issuing the execution instruction, and wherein the processor is configured to extract a sentence or a feature word to be reflected in the query from the workflow information.

According to (((7))), the information processing apparatus according to (((6))), wherein the sentence or the feature word to be reflected in the query is extracted from information indicating a case and a phase of the workflow information.

According to (((8))), the information processing apparatus according to any one of (((1))) to (((7))), wherein the processor is configured to perform control in such a manner that a processed query that has been obtained by the processing is displayed.

According to (((9))), the information processing apparatus according to (((8))), wherein the processor is configured to perform control in such a manner that a plurality of processed queries are displayed and receive a selection from the user.

According to (((10))), the information processing apparatus according to any one of (((1))) to (((9))), wherein the processor is configured to determine the degree of abstractness of the received query and, in a case where the degree of abstractness is equal to or more than a threshold, perform the processing of the query.

According to (((11))), the information processing apparatus according to (((10))), wherein the degree of abstractness is determined based on the number of search results obtained by the natural text search conducted based on the query.

According to (((12))), the information processing apparatus according to (((10))), wherein the degree of abstractness is determined based on the number of predetermined keywords included in search results obtained by the natural text search conducted based on the query.

According to (((13))), an information processing program causing a computer to execute a process comprising: receiving an input of a query for a natural text search from a user; receiving an execution instruction for the natural text search from the user; acquiring information indicating a situation in which the execution instruction for the natural text search was issued; and performing, based on the acquired information, processing of the query.

What is claimed is:

1. An information processing apparatus comprising:
a processor configured to:
receive an input of a query for a natural text search from a user;
receive an execution instruction for the natural text search from the user;
acquire information indicating a situation in which the execution instruction for the natural text search was issued; and
perform, based on the acquired information, processing of the query.

2. The information processing apparatus according to claim 1,
wherein the information indicating the situation in which the execution instruction was issued from the user is content information that the user was referring to when issuing the execution instruction, and
wherein the processor is configured to extract a sentence or a feature word to be reflected in the query from the content information.

3. The information processing apparatus according to claim 2, wherein the processing is adding the extracted sentence or feature word to the query.

4. The information processing apparatus according to claim 2, wherein the processing is generating a new query based on the extracted sentence or feature word and the query.

5. The information processing apparatus according to claim 2, wherein the processor is configured to provide feature words with scores and extract a predetermined number of feature words in descending order of the scores.

6. The information processing apparatus according to claim 1,
wherein the information indicating the situation in which the execution instruction was issued from the user is workflow information that the user was referring to when issuing the execution instruction, and
wherein the processor is configured to extract a sentence or a feature word to be reflected in the query from the workflow information.

7. The information processing apparatus according to claim 6, wherein the sentence or the feature word to be reflected in the query is extracted from information indicating a case and a phase of the workflow information.

8. The information processing apparatus according to claim 1, wherein the processor is configured to perform control in such a manner that a processed query that has been obtained by the processing is displayed.

9. The information processing apparatus according to claim 8, wherein the processor is configured to perform control in such a manner that a plurality of processed queries are displayed and receive a selection from the user.

10. The information processing apparatus according to claim 1, wherein the processor is configured to determine the degree of abstractness of the received query, and in a case where the degree of abstractness is equal to or more than a threshold, perform the processing of the query.

11. The information processing apparatus according to claim 10, wherein the degree of abstractness is determined based on the number of search results obtained by the natural text search conducted based on the query.

12. The information processing apparatus according to claim 10, wherein the degree of abstractness is determined based on the number of predetermined keywords included in search results obtained by the natural text search conducted based on the query.

13. An information processing method comprising:
receiving an input of a query for a natural text search from a user;
receiving an execution instruction for the natural text search from the user;
acquiring information indicating a situation in which the execution instruction for the natural text search was issued; and
performing, based on the acquired information, processing of the query.

14. A non-transitory computer readable medium storing a program causing a computer to execute a process for information processing, the process comprising:
receiving an input of a query for a natural text search from a user;
receiving an execution instruction for the natural text search from the user;
acquiring information indicating a situation in which the execution instruction for the natural text search was issued; and
performing, based on the acquired information, processing of the query.
